(19) United States
(12) Patent Application Publication
(10) Pub. No.: US 2018/0224223 A1
(43) Pub. Date: Aug. 9, 2018

(54) Liquid Cooling Block, Liquid Cooling Heat Dissipation System And Laser Projector

(71) Applicant: Qingdao Hisense Electronics Co., Ltd, Qingdao (CN)

(72) Inventor: Zhe XING, Qingdao (CN)

(21) Appl. No.: 15/941,500

(22) Filed: Mar. 30, 2018

(30) Foreign Application Priority Data
Sep. 26, 2017 (CN) 201710882519.0

(51) Int. Cl. F28F 13/08; F28D 15/00; H04N 9/31

(52) U.S. Cl. CPC F28F 13/08; F28D 15/00; F28D 2021/0028; H04N 9/3144; H04N 9/3161

(57) ABSTRACT

The present disclosure relates to the field of laser display technology and discloses a liquid cooling block, a liquid cooling heat dissipation system and a laser projector. The liquid cooling block includes a housing. A liquid inlet, a liquid outlet and at least two sets of cooling fins are arranged on the housing. At least two liquid storage chambers are formed in the housing. Each of the at least two liquid storage chambers corresponds to one set of the at least two sets of cooling fins. The at least two liquid storage chambers share the liquid inlet and the liquid outlet. One liquid storage chamber and its corresponding cooling fins have a total heat dissipation efficiency different from a total heat dissipation efficiency of another liquid storage chamber and its corresponding cooling fins.

### CROSS-REFERENCE TO RELATED APPLICATION

This application claims the benefit and priority of Chinese Patent Application No. CN 201710882519.0, filed Sep. 26, 2017. The entire disclosure of the above application is incorporated herein by reference.

### FIELD

The present disclosure relates to the field of laser display technology and particularly to a liquid cooling block, a liquid cooling heat dissipation system and a laser projector.

### BACKGROUND

This section provides background information related to the present disclosure which is not necessarily prior art.

Laser display technology is the fourth generation of display technology, following black and white display technology, color display technology and high-definition digital display technology, and has a significant research value. But strong coherence of a laser as a display light source may cause speckles on a screen, severely affecting definition of an image on the screen. Furthermore, red lasers currently in use, which have long wavelengths, are especially prone to cause speckles.

Speckles refer to granular, dark and bright spots on the screen produced by constructive interference and destructive interference of scattered light when a coherent light source irradiates a rough surface. In order to suppress the speckles so that they cannot be recognized by the human eyes, the coherence of the laser needs to be reduced.

To enable a laser to work stably and efficiently, usually a heat absorber is arranged in the laser. Liquid cooling block is a common heat absorber in a laser. A liquid cooling block can be a metal block made of copper or aluminum and have an inner water channel. Or, the liquid cooling block can include a heat exchanger made of copper or aluminum, the heat exchanger contacts a heat source and absorbs heat produced by the heat source. The heat exchanger generally consists of an upper chamber, a lower chamber, a liquid inlet, a liquid outlet and a seal ring. The contact portion of the upper and lower chambers is sealed by the seal ring to form a seal chamber, and the cavity between the upper and lower chambers contains the cooling liquid.

### SUMMARY

This section provides a general summary of the disclosure, and is not a comprehensive disclosure of its full scope or all of its features.

In one aspect, some embodiments of the disclosure provide a liquid cooling block. The liquid cooling block includes a housing. A liquid inlet, a liquid outlet and at least two sets of cooling fins are arranged on the housing. At least two liquid storage chambers are formed in the housing. Each of the at least two liquid storage chambers corresponds to one set of the at least two sets of cooling fins. The at least two liquid storage chambers share the liquid inlet and the liquid outlet, so that cooling liquid enters the at least two liquid storage chambers via the liquid inlet and then flows out of the liquid cooling block via the liquid outlet. And one of the at least two liquid storage chambers and corresponding cooling fins thereof have a total heat dissipation efficiency different from a total heat dissipation efficiency of another one of the at least two liquid storage chambers and corresponding cooling fins thereof.

In another aspect, some embodiments of the disclosure further provide a liquid cooling heat dissipation system. The liquid cooling heat dissipation system includes a heat exchanger, a circulation pump, a liquid tank, and a liquid cooling block. The heat exchanger, the circulation pump, the liquid tank, and the liquid cooling block are connected by liquid tubes to form a circulation system. The liquid cooling block includes a housing. A liquid inlet, a liquid outlet and at least two sets of cooling fins are arranged on the housing. At least two liquid storage chambers are formed in the housing. Each of the at least two liquid storage chambers corresponds to one set of the at least two sets of cooling fins. The at least two liquid storage chambers share the liquid inlet and the liquid outlet, so that cooling liquid enters the at least two liquid storage chambers via the liquid inlet and then flows out of the liquid cooling block via the liquid outlet. And one of the at least two liquid storage chambers and corresponding cooling fins thereof have a total heat dissipation efficiency different from a total heat dissipation efficiency of another one of the at least two liquid storage chambers and corresponding cooling fins thereof.

In another aspect, some embodiments of the disclosure further provide a laser projector. The laser projector includes a liquid cooling heat dissipation system. The liquid cooling heat dissipation system includes a heat exchanger, a circulation pump, a liquid tank, and a liquid cooling block. The heat exchanger, the circulation pump, the liquid tank, and the liquid cooling block are connected by liquid tubes to form a circulation system. The liquid cooling block includes a housing. A liquid inlet, a liquid outlet and at least two sets of cooling fins are arranged on the housing. At least two liquid storage chambers are formed in the housing. Each of the at least two liquid storage chambers corresponds to one set of the at least two sets of cooling fins. The at least two liquid storage chambers share the liquid inlet and the liquid outlet, so that cooling liquid enters the at least two liquid storage chambers via the liquid inlet and then flows out of the liquid cooling block via the liquid outlet. And one of the at least two liquid storage chambers and corresponding cooling fins thereof have a total heat dissipation efficiency different from a total heat dissipation efficiency of another one of the at least two liquid storage chambers and corresponding cooling fins thereof.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure

### DRAWINGS

The drawings described herein are for illustrative purposes only of selected embodiments and not all possible implementations, and are not intended to limit the scope of the present disclosure.

FIG. 1 is a structural schematic diagram of a liquid cooling block according to some embodiments of the disclosure.

FIG. 2 is a sectional schematic diagram of a housing of another liquid cooling block according to some embodiments of the disclosure.

FIG. 3 is a sectional schematic diagram of a partial housing of another liquid cooling block according to some embodiments of the disclosure.

FIG. 4A is a sectional schematic diagram of another liquid cooling block's housing sectioned at a water inlet position according to some embodiments of the disclosure.

FIG. 4B is a sectional schematic diagram of another liquid cooling block's housing sectioned at a water outlet position according to the embodiments as shown in FIG. 4A.

FIG. 5A is a sectional schematic diagram of another liquid cooling block's housing sectioned at a water outlet position according to some embodiments of the disclosure.

FIG. 5B is a sectional schematic diagram of another liquid cooling block's housing sectioned at a water inlet position according to the embodiments as shown in FIG. 5A.

FIG. 6 is a structural schematic diagram of a liquid cooling heat dissipation system according to some embodiments of the disclosure.

Corresponding reference numerals indicate corresponding parts or features throughout the several views of the drawings.

### DETAILED DESCRIPTION

Example embodiments will now be described more fully with reference to the accompanying drawings.

Technical solutions of embodiments of the disclosure are described below with reference to the drawings. Apparently the embodiments described herein are only a part of the embodiments of the disclosure, not all of the embodiments. Based upon the embodiments described herein, all other embodiments obtained by those skilled in the art without creative work pertain to the protection scope of the disclosure.

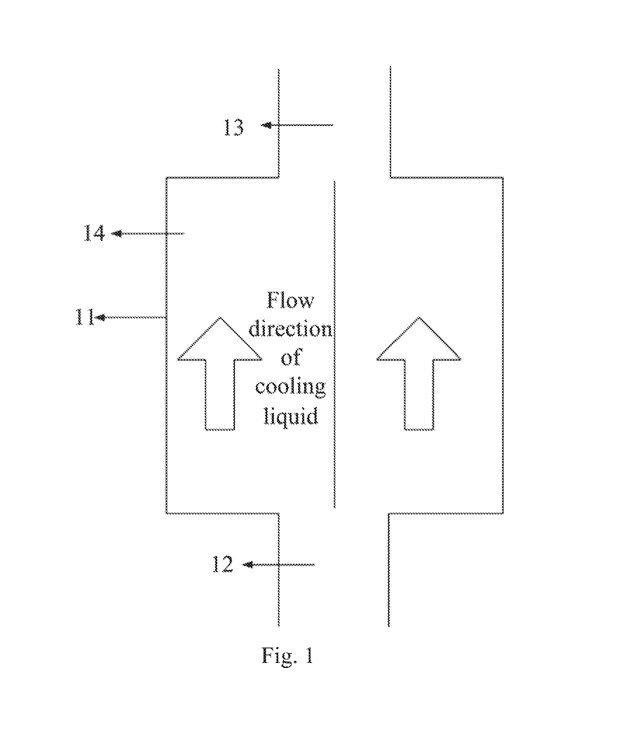

As illustrated by FIG. 1, some embodiments of the disclosure provide a liquid cooling block 1. The liquid cooling block 1 includes a housing 11. A liquid inlet 12, a liquid outlet 13 and at least two sets of cooling fins (not shown in the figure) are arranged on the housing 11. At least two liquid storage chambers 14 are formed in the housing 11, and each liquid storage chamber 14 corresponds to a set of cooling fins. The at least two liquid storage chambers 14 share the liquid inlet 12 and the liquid outlet 13, so that cooling liquid enters the at least two liquid storage chambers 14 via the liquid inlet 12 and then flows out of the liquid cooling block 1 via the liquid outlet 13. One of the at least two liquid storage chambers 14 and corresponding cooling fins thereof has a total heat dissipation efficiency different from a total heat dissipation efficiency of another one of the at least two liquid storage chambers 14 and corresponding cooling fins thereof.

In some embodiments, space inside the housing 11 is divided into at least two liquid storage chambers 14. The cooling liquid enters the at least two liquid storage chambers 14 via the liquid inlet 12, absorbs heat from laser-emitting elements (not shown in the figure) while passing through the at least two liquid storage chambers 14, and then drains out of the liquid cooling block 1 via the liquid outlet 13. Since different liquid storage chambers 14 and corresponding cooling fins have different total heat dissipation efficiencies, efficiency of heat exchange between laser-emitting elements in contact with the housing 11 and the cooling liquid varies according to different liquid storage chambers 14.

In some embodiments, the laser-emitting elements can include at least two laser emitters which emit laser of a same color. The at least two laser emitters can be divided into at least two parts, each of the at least two parts includes at least one laser emitter, and corresponds to a different liquid storage chamber 14. Since a total heat dissipation efficiency of a liquid storage chamber 14 and its corresponding cooling fins is different from a total heat dissipation efficiency of another liquid storage chamber 14 and its corresponding cooling fins, dominant wavelengths of lasers emitted by laser emitters of different parts may have different levels of shift when the dominant wavelengths of the lasers emitted by the at least two laser emitters are similar. Thus the dominant wavelengths of the lasers emitted by the laser-emitting elements are different, and the lasers with different dominant wavelengths can reduce the occurrence of the speckle phenomenon in the light path.

In some embodiments, the laser-emitting elements in contact with the housing 11 can include at least two laser emitters which emit lasers of different colors. Laser emitters emitting lasers of different colors may correspond to different liquid storage chambers 14, respectively, thereby meeting different heat dissipation efficiency requirements of laser light sources emitting lasers of different colors. For example, a laser emitter requiring a high heat dissipation efficiency can be in contact with a liquid storage chamber 14 having a better heat dissipation effect.

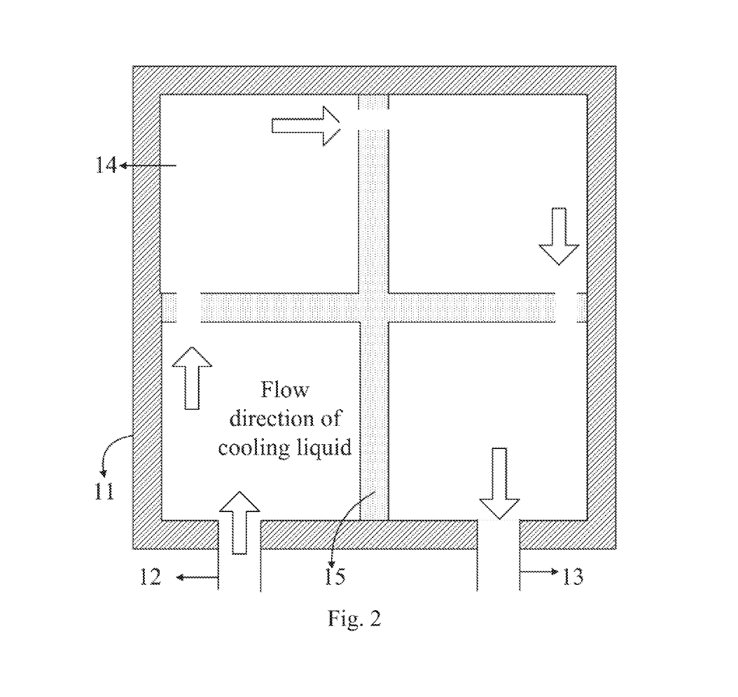

As shown in FIG. 2, according to some embodiments of the disclosure, the housing 11 can have a notch for forming the liquid storage chambers 14. The notch for forming the liquid storage chambers 14, the liquid inlet 12 and the liquid outlet 13 can be arranged on the upper half of the housing 11, the at least two sets of cooling fins (not shown in the figure) can be arranged on the lower half of the housing 11 and correspond to the liquid storage chambers 14 in a one-to-one correspondence relationship. Or, the notch for forming the liquid storage chambers 14, the liquid inlet 12 and the liquid outlet 13 can be arranged on the lower half of the housing 11, and the at least two sets of cooling fins corresponding to the liquid storage chambers 14 in a one-to-one relationship are arranged on the upper half of the housing 11, which is not limited by the embodiments of the disclosure. Moreover, a baffle 15 can be arranged between the at least two liquid storage chambers 14. In one example as illustrated by FIG. 2, the cooling liquid can flow between two adjacent liquid storage chambers 14. Accordingly, the liquid inlet 12 only needs to be connected to one liquid storage chamber 14 and the liquid outlet 13 only needs to be connected to another liquid storage chamber 14. The cooling liquid flowing from the liquid inlet 12 can flow into the liquid storage chamber 14 connected to the liquid inlet 12, then flow into the other liquid storage chambers 14 in turn until the cooling liquid flows into the liquid storage chamber 14 connected to the liquid outlet 13 and finally flows out via the liquid outlet 13.

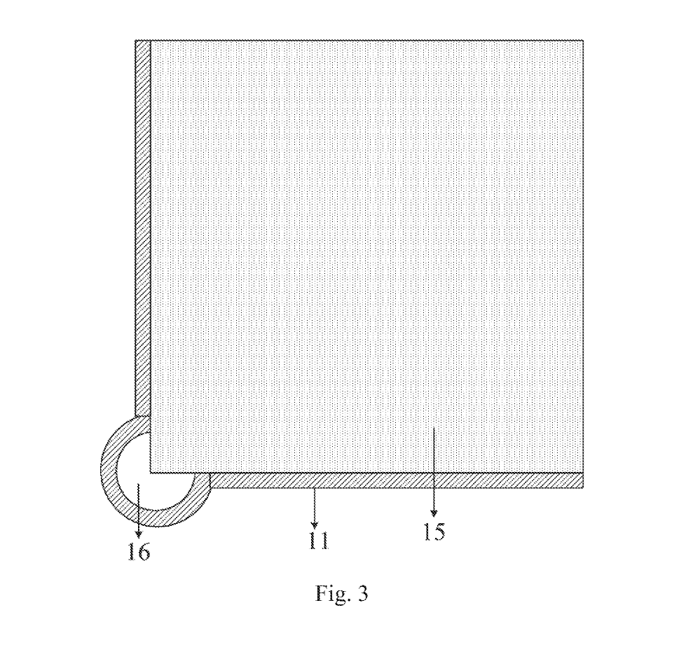

In order to enable the cooling liquid to flow between adjacent liquid storage chambers 14, as shown in FIG. 2, through holes can be arranged on the baffle 15; or, as shown in FIG. 3, at least one first channel 16 can be formed on the inner wall of the housing 11. Two ends of each of the at least one first channel 16 are located in two liquid storage chambers 14 respectively, and the bottom of each first channel 16 does not contact with the baffle 15, so that the cooling liquid can flow through two adjacent liquid storage chambers 14 via each first channel 16. For example, if the two ends of each first channels 16 are located in two adjacent liquid storage chambers 14, respectively, then as long as three first channels 16 are formed on the inner wall of the housing 11, the cooling liquid flowing from the liquid inlet 12 could drain out from the liquid outlet 13 after flowing through four liquid storage chambers 14 successively. As such, the structure of the liquid cooling block 1 is simple and easy to fabricate. The length, cross-sectional area and positions in liquid storage chambers 14 of the first channel 16 can be designed according to practical conditions of the liquid cooling block 1.

According to some other embodiments of the disclosure, both through hole(s) in the baffle 15 and first channel(s) 16 on the inner wall of the housing 11 can be used to enable the cooling liquid to flow through at least two liquid storage chambers 14 to simplify the structure of the housing 11. Other structures can also be used to enable the cooling liquid to flow into the liquid inlet 12, then flow from one liquid storage chamber 14 into other liquid storage chambers 14 successively, and then flow out from the liquid outlet 13.

In the embodiments as shown in FIGS. 2 and 3, the cooling liquid flowing from the liquid inlet 12 flows through different liquid storage chambers 14 successively, absorbs heat from a part of the laser-emitting elements in contact with a liquid storage chamber 14 when flowing through the liquid storage chamber 14, decreasing a temperature of the part of the laser-emitting elements in contact with the liquid storage chamber 14, and finally, having an increased temperature, drains out of the liquid cooling block 1 via the liquid outlet 13. Since each set of cooling fins corresponds to one liquid storage chamber 14, different liquid storage chambers 14 and corresponding cooling fins have different total heat dissipation efficiencies, efficiency of heat exchange between a part of the laser-emitting elements in contact with a liquid storage chamber 14 and the cooling liquid varies according to different liquid storage chambers 14. In this way, temperatures of the laser-emitting elements present a gradient distribution and have a wide distribution range, so that the laser-emitting elements in contact with the liquid cooling block 1 can produce a uniformly-distributed spectrum.

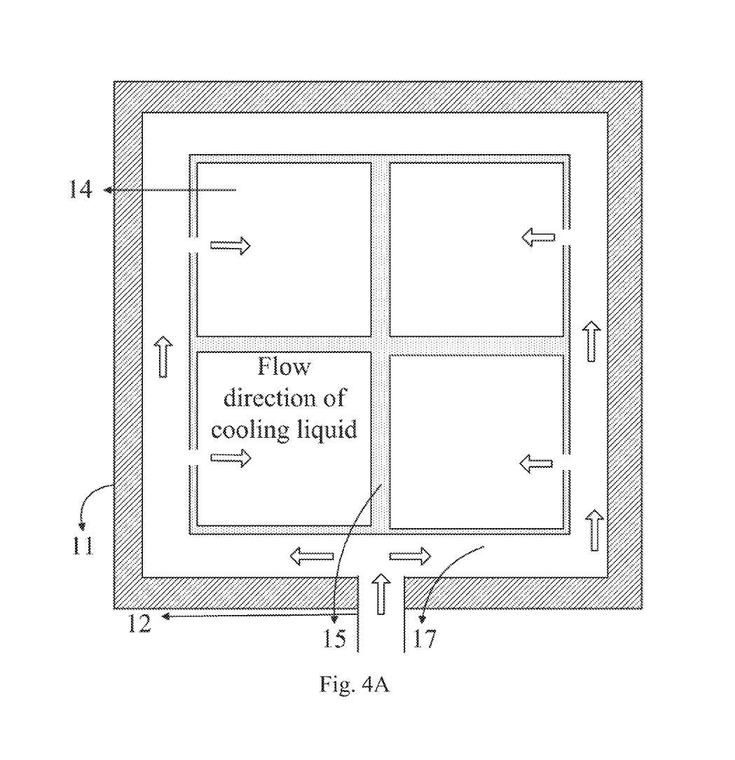

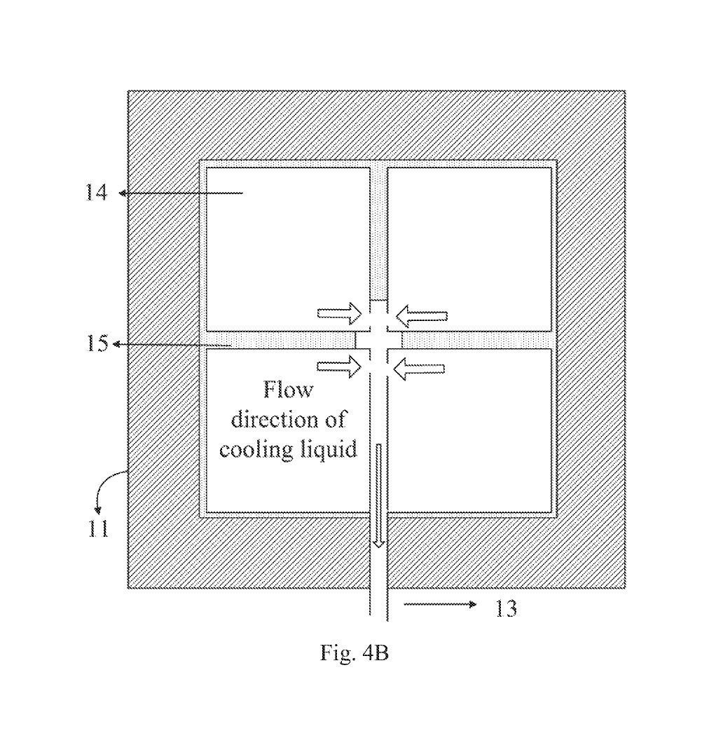

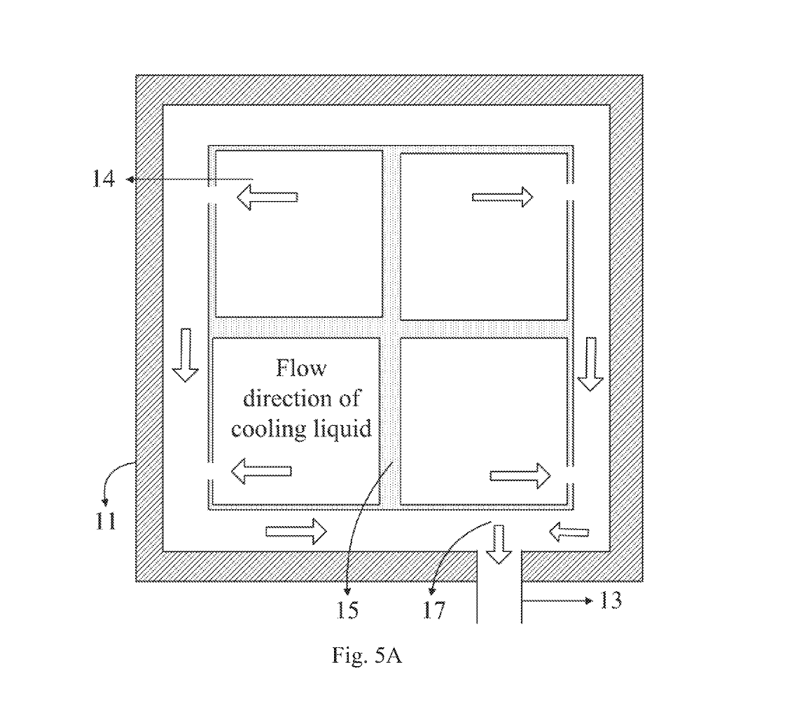

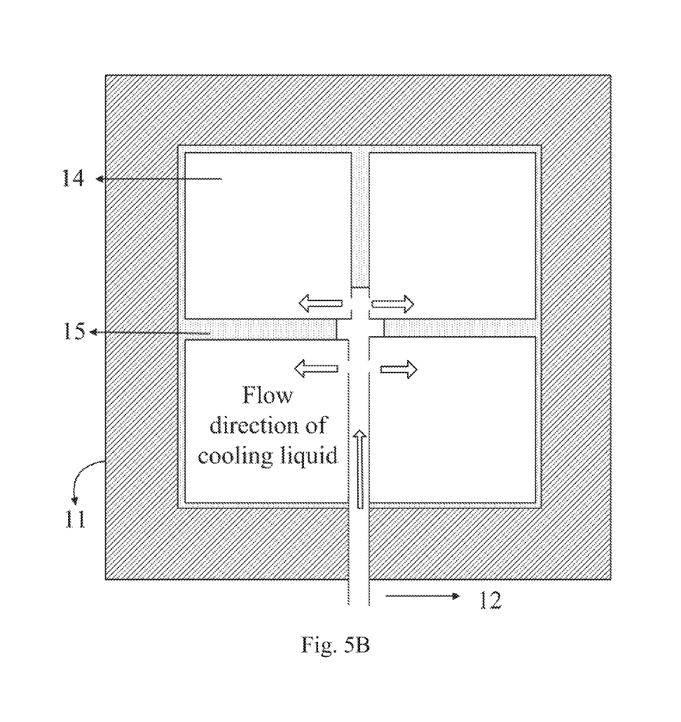

In some other embodiments of the disclosure, the at least two liquid storage chambers 14 can be connected with the liquid inlet 12 to share the liquid inlet 12. Or, the at least two liquid storage chambers 14 can be connected with the liquid outlet 13 to share the liquid outlet 13. In these embodiments, in order to simplify the structure of the housing 11, as shown in FIGS. 4A, 4B, 5A and 5B, a second channel 17 connecting with the liquid inlet 12 (or the liquid outlet 13) and connecting with each liquid storage chamber 14 respectively can be formed on the inner wall of the housing 11. In the embodiments illustrated by FIGS. 4A, 4B, 5A and 5B, the second channel 17 is a closed ring. In some other embodiments, the second channel 17 can have a non-closed shape.

As shown in FIGS. 4A and 4B, in an embodiment, the second channel 17 can be connected with the liquid inlet 12 and each liquid storage chamber 14 respectively, while the liquid outlet 13 is connected with each liquid storage chamber 14 respectively. Thus, after flowing from the liquid inlet 12 into the second channel 17, the cooling liquid can be allocated to each liquid storage chamber 14 through the second channel 17 to flow into different liquid storage chambers 14 at the same time, and flow into the liquid outlet 13 to drain out after heat exchange.

As shown in FIGS. 5A and 5B, in another embodiment, the second channel 17 can be connected with the liquid outlet 13, while the liquid inlet 12 is connected with each liquid storage chamber 14 respectively. Thus, after flowing from the liquid inlet 12, the cooling liquid can be allocated to each liquid storage chamber 14 through the liquid inlet 12 to flow into different liquid storage chambers 14 at the same time, and flow into the liquid outlet 13 to drain out after the heat exchange.

The cross-sectional area of the second channel 17 and its position on the inner wall of the housing 11 can be designed according to practical conditions of the liquid cooling block 1. In the exemplary embodiments as shown in FIGS. 4A, 4B, 5A and 5B, the second channel 17 can be arranged in the upper half of the housing 11, but in other exemplary embodiments, the second channel 17 can also be arranged in the lower half of the housing 11, or one part of the second channel 17 can be arranged in the upper half of the housing 11 and the other part can be arranged in the lower half of the housing 11.

In order to simplify the structure of the housing 11, other structures can be used that enable the cooling liquid flowing from the liquid inlet 12 to enter into different liquid storage chambers 14 at the same time and then flow out from the liquid outlet 13.

In some other embodiments, structures illustrated by FIGS. 2 to 5B can be combined with each other so that the at least two liquid storage chambers 14 can share the liquid inlet 12 and the liquid outlet 13. This is not limited by the embodiments of the disclosure.

In some embodiments, for convenient manufacturing, the baffle 15 and the housing 11 can be formed integrally, e,g., can be formed integrally by die casting. There is no need for other manufacturing processes, the precision is higher and the molding is convenient.

In some embodiments, sizes of any two liquid storage chambers 14 formed in the housing 11 can be the same or different. In a case where the sizes of at least two liquid storage chambers 14 are different, heat dissipation effects of the at least two liquid storage chambers 14 are also different due to the different sizes of the liquid storage chambers 14.

In some embodiments, flow velocities of the cooling liquid in different liquid storage chambers 14 can be the same or different. In a case where flow velocities of the cooling liquid in two liquid storage chambers 14 are different, the heat dissipation effects of the two liquid storage chambers 14 are also different due to the different flow velocities of the cooling liquid therein.

In some embodiments, different cooling fins can have differences in at least one of the following aspects so that the different cooling fins have different heat dissipation efficiencies: heat conduction coefficients are different, heat dissipation areas are different, and air cooling environments are different. The different air cooling environments can be caused for example by different fan speeds. A heat dissipation area of a cooling fin can include a contact area of the cooling fin with the air, and/or a contact area of the cooling fin with the cooling liquid.

In the above-mentioned liquid cooling block 1, if heat dissipation efficiencies of different liquid storage chambers 14 are different, temperatures of parts of the laser-emitting elements corresponding to the different liquid storage chambers 14 are different, producing desired temperature differences.

In some embodiments, for two adjacent sets of cooling fins, one set of cooling fins include a plurality of first cooling fins and the other set of cooling fins include a plurality of second cooling fins. One set of cooling fins and a corresponding liquid storage chamber 14 can have a total heat dissipation efficiency different from that of the other set of cooling fins and a corresponding liquid storage chamber 14 in the following modes.

Mode one: heat dissipation areas of the first and second cooling fins are different, and flow velocities of the cooling liquid flowing respectively through the first and second cooling fins are the same.

Mode two: the heat dissipation areas of the first and second cooling fins are the same, and the flow velocities of the cooling liquid flowing respectively through the first and second cooling fins are different.

Mode three: the heat dissipation areas of the first and second cooling fins are different, and the flow velocities of the cooling liquid flowing respectively through the first and second cooling fins are different.

In a case where the flow velocities of the cooling liquid flowing respectively through the first and second cooling fins are the same, the heat dissipation efficiency increases as the heat dissipation area increases. In a case where the flow velocities of the cooling liquid flowing respectively through the first and second cooling fins are different but the heat dissipation areas of the first and second cooling fins are same, a cooling fin through which the flow velocity of the cooling liquid flowing is faster has a higher heat dissipation efficiency.

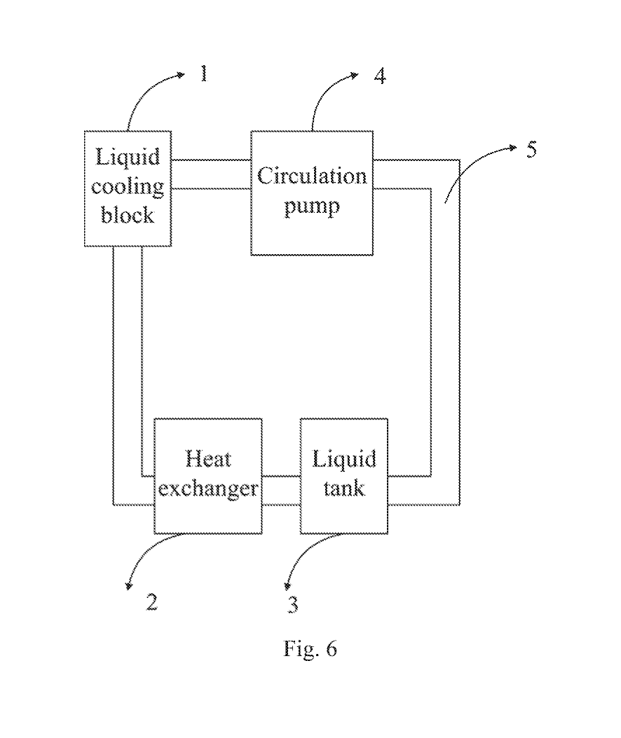

As shown in FIG. 6, some embodiments of the disclosure further provide a liquid cooling heat dissipation system. The liquid cooling heat dissipation system includes a heat exchanger 2, a circulation pump 4, a liquid tank 3, and the liquid cooling block 1 according to any one of the embodiments described above. The liquid cooling block 1, the heat exchanger 2, the circulation pump 4 and the liquid tank 3 are connected by the liquid tubes 5 to form a circulation system.

In the liquid cooling heat dissipation system described above, the heat exchanger 2, the liquid tank 3, the circulation pump 4 and the liquid cooling block 1 are connected by the liquid tubes 5 to form the closed circulation system. Cooling liquid outputs from the liquid tank 3 with the help of the circulation pump 4, takes away most heat when flowing through the liquid cooling block 1, then enters the heat exchanger 2, and returns to the liquid tank 3 after being cooled by the heat exchanger 2. The cooling liquid takes heat away from laser-emitting elements when flowing through the liquid cooling block 1. Since temperatures of different parts of the laser-emitting elements corresponding to different liquid storage chambers 14 in the liquid cooling block 1 are different, dominant wavelengths of the lasers emitted by the laser-emitting elements are different, and the lasers with different dominant wavelengths can reduce the occurrence of the speckle phenomenon in the light path.

Moreover, some embodiments of the disclosure further provide a laser projector, which includes the liquid cooling heat dissipation system described above.

Since the liquid cooling heat dissipation system described above can reduce the occurrence of the speckle phenomenon, the laser projector having the liquid cooling heat dissipation system described above can also reduce the occurrence of the speckle phenomenon and improve the display effect.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A liquid cooling block, comprising a housing, wherein:
a liquid inlet, a liquid outlet and at least two sets of cooling fins are arranged on the housing;
at least two liquid storage chambers are formed in the housing;
each of the at least two liquid storage chambers corresponds to one set of the at least two sets of cooling fins;
the at least two liquid storage chambers share the liquid inlet and the liquid outlet, so that cooling liquid enters the at least two liquid storage chambers via the liquid inlet and then flows out of the liquid cooling block via the liquid outlet; and
one of the at least two liquid storage chambers and corresponding cooling fins thereof have a total heat dissipation efficiency different from a total heat dissipation efficiency of another one of the at least two liquid storage chambers and corresponding cooling fins thereof.

2. The liquid cooling block according to claim 1, wherein a channel exists between two adjacent liquid storage chambers of the at least two liquid storage chambers for the cooling liquid to flow between the two adjacent liquid storage chambers.

3. The liquid cooling block according to claim 1 wherein a baffle is arranged between the at least two liquid storage chambers, and the channel is arranged on the baffle.

4. The liquid cooling block according to claim 1, wherein a baffle is arranged between the at least two liquid storage chambers; a first channel is formed on an inner watt of the housing, two ends of the first channel are located in two liquid storage chambers respectively, and a bottom of the first channel does not contact with the baffle.

5. The liquid cooling block according to damn herein the baffle and the housing are formed integrally.

6. The liquid cooling block according to claim 4, wherein the baffle and the housing are formed integrally.

7. The liquid cooling block according to claim 1, wherein each of the at least two liquid storage chambers is connected with the liquid inlet, or each of the at least two liquid storage chambers is connected with the liquid outlet.

8. The liquid cooling block according to claim 7, wherein a second channel is formed on an inner wall of the housing, the second channel is connected with the liquid inlet, and the liquid outlet is connected with each liquid storage chamber, respectively; or
the second channel is connected with the liquid outlet, and the liquid inlet is connected with the each liquid storage chamber, respectively.

9. The liquid cooling block according to claim 1, wherein two of the at least two liquid storage chambers have different sizes, or a flow velocity of the cooling liquid varies in liquid storage chambers corresponding to different sets of the at least two sets of cooling fins.

10. The liquid cooling block according to claim 1, wherein the at least two sets of cooling fins are different in at least one of following aspects:
heat conduction coefficients of the at least two sets of cooling fins are different;
contact areas of the at least two sets of cooling fins with air are different;
contact areas of the at least two sets of cooling fins with the cooling liquid are different; and
air cooling environments of the at least two sets of cooling fins are different.

11. A liquid cooling heat dissipation system, comprising a heat exchanger, a circulation pump, a liquid tank, and a liquid cooling block connected by liquid tubes to form a circulation system; wherein
the liquid cooling block includes a housing;
a liquid inlet, a liquid outlet and at least two sets of cooling fins are arranged on the housing;
at least two liquid storage chambers are formed in the housing;
each of the at least two liquid storage chambers corresponds to one set of the at least two sets of cooling fins;
the at least two liquid storage chambers share the liquid inlet and the liquid outlet, so that cooling liquid enters the at least two liquid storage chambers via the liquid inlet and then flows out of the liquid cooling block via the liquid outlet; and
one of the at least two liquid storage chambers and corresponding cooling fins thereof have a total heat dissipation efficiency different from a total heat dissipation efficiency of another one of the at least two liquid storage chambers and corresponding cooling fins thereof.

12. A laser projector, comprising a liquid cooling heat dissipation system, wherein
the liquid cooling heat dissipation system comprises a heat exchanger, a circulation pump, a liquid tank, and a liquid cooling block connected by liquid tubes to form a circulation system;
the liquid cooling block includes a housing;
a liquid inlet, a liquid outlet and at least two sets of cooling fins are arranged on the housing;
at least two liquid storage chambers are formed in the housing;
each of the at least two liquid storage chambers corresponds to one set of the at least two sets of cooling fins;
the at least two liquid storage chambers share the liquid inlet and the liquid outlet, so that cooling liquid enters the at least two liquid storage chambers via the liquid inlet and then flows out of the liquid cooling block via the liquid outlet; and
one of the at least two liquid storage chambers and corresponding cooling fins thereof have a total heat dissipation efficiency different from a total heat dissipation efficiency of another one of the at least two liquid storage chambers and corresponding cooling fins thereof.
